(19) United States
(12) Patent Application Publication
(10) Pub. No.: US 2005/0028746 A1
(43) Pub. Date: Feb. 10, 2005

(54) Aquatic habitat

(76) Inventor: Howard S. Mitz, Littleton, NH (US)

Correspondence Address: BOURQUE & ASSOCIATES, P.A., Suite 301, 835 Hanover Street, Manchester, NH, 03104, US

(21) Appl. No.: 10/638,134

(22) Filed: Aug. 8, 2003

(51) Int. Cl. A01K 63/00

(52) U.S. Cl. 119/250

(57) ABSTRACT

An aquatic habitat for holding fluid therein and having a first aquarium in fluid connection with a second aquarium via a hollow connector, hollow extension, elbow connector, or other shaped connector. The connector or extension has a portion of its length above the fluid in the first aquarium.

### TECHNICAL FIELD OF THE INVENTION

The present invention relates to aquariums for containing and raising aquatic animals, and more particularly, to an aquatic habitat having a plurality of aquariums in fluid connection with each other via at least one hollow connector.

### DESCRIPTION OF THE RELATED ART

Most aquariums have transparent sides and a bottom defining a cavity or tank with a generally open top region, for holding water and aquatic animals. Aquatic animals are generally free to swim within the aquarium.

Typically, aquariums have a rectangular or bulbous shape. A disadvantage with these types of aquariums is the limited area in which the aquatic animals can swim. Further, due to the very low interaction between aquatic animals and the viewer, there is a need to have an apparatus that adds to the enjoyment of the viewer.

### SUMMARY OF THE INVENTION

The present invention is a novel aquatic habitat having a plurality of aquariums in fluid connection with each other via hollow connectors, hollow extensions, elbow connectors, and/or other shaped connectors. At least one of the aquariums has a vacuum port for operatively connecting a vacuum pump thereto for creating a vacuum by evacuating entrapped air in the aquarium, thereby filling said aquarium.

### BRIEF DESCRIPTION OF THE DRAWINGS

These and other features and advantages of the present invention will be better understood by reading the following detailed description, taken together with the drawings wherein:

FIG. 1 is a side view of an aquatic habitat according to the present invention having two aquariums in fluid connection with each other;

FIG. 2 is a side view of an alternative embodiment of the aquatic habitat shown in FIG. 1;

FIG. 3 is a side view of another embodiment of the aquatic habitat according to the present invention having a plurality of aquariums in fluid connection with each other; and

FIG. 4 is a side view of an alternative embodiment of the aquatic habitat shown in FIG. 3.

### DETAILED DESCRIPTION

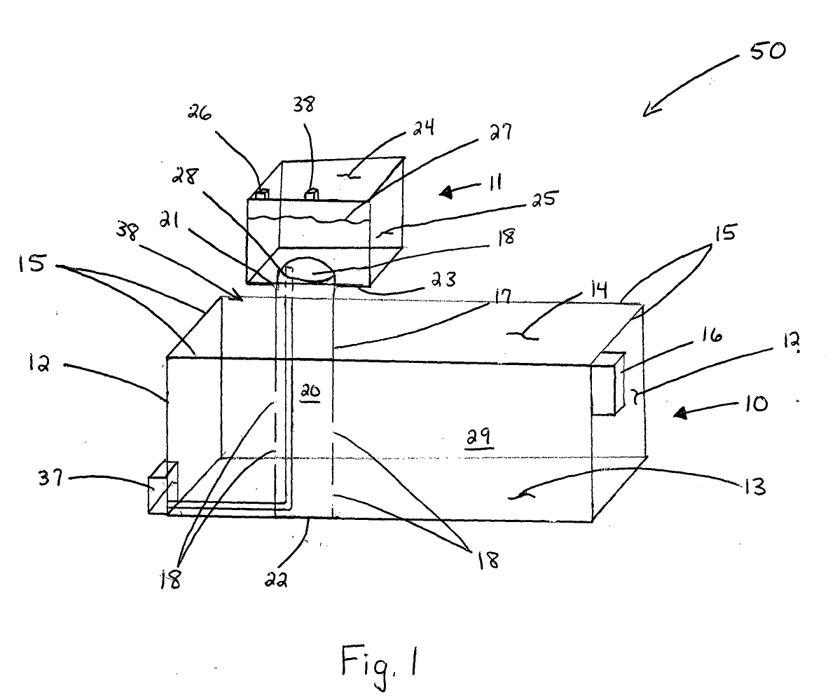

An aquatic habitat 50, FIG. 1, in accordance with the present invention includes a first aquarium 10 in fluid connection with a second aquarium 11. The first aquarium 10 has a plurality of sides 12 hermetically sealed to a bottom 13. In the preferred embodiment, the sides 12 are transparent. A top 14 may be permanently or removably mounted to top edges 15 of the sides 12. The top 14 may contain a light (not shown) for heating or illuminating the water in the first aquarium 10 as well known in the art. The first aquarium 10 also has an aquarium filter 16 operatively connected to the first aquarium 10 for circulating and filtering the water in the first aquarium 10 as is also well known in the art. Although the first aquarium 10 is shown in the shape of a rectangle, this is for illustrative purposes only and the present invention contemplates and may be implemented with an aquarium of essentially any shape.

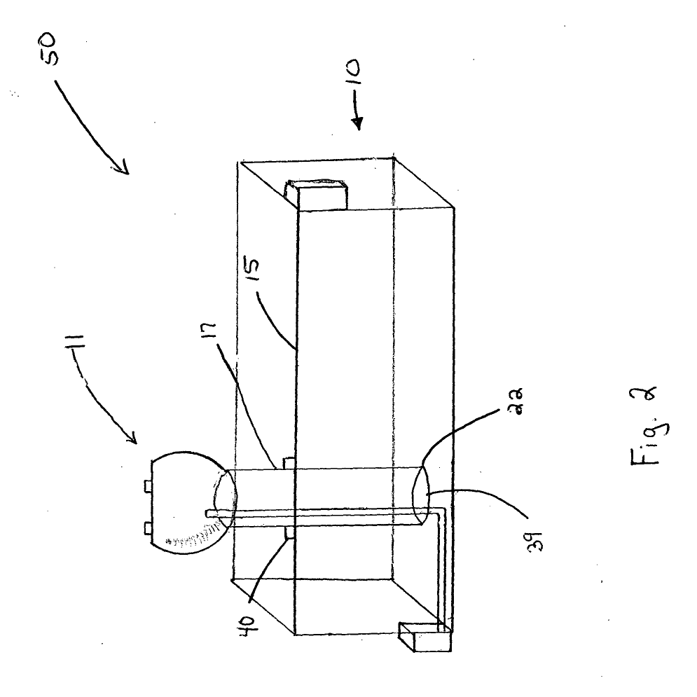

The second aquarium 11 has a plurality of sides 25 in the case of a rectangle or other geometric shape having intersecting side walls or one continuous side 25 in the case of a circular shape, as shown in FIG. 2, hermetically sealed to a top 24, a bottom 23, and a hollow connector tube or chamber 17. The second aquarium 11 can be designed in a variety of shapes including, but not limited to, rectangular, square, or bulbous so long as the second aquarium 11 is hermetically sealed to the hollow connector 17.

A vacuum port 26 is operatively provided on the second aquarium 11. A vacuum pump (not shown) can be removably attached to the vacuum port 26 to evacuate entrapped air between the top of the water level 27 and the top 24 of the second aquarium 11, thereby reducing the pressure between the top of the water level 27 and the top 24 of the second aquarium 11. The vacuum pump is of sufficient size to evacuate the entrapped air, and the size of the vacuum pump will depend on the size of the aquariums 10, 11 being used.

In an alternative embodiment, a water inlet 38 is provided to pass water into the second aquarium 11. When the water inlet 38 is not in use, it precludes water or air from passing through. A second aquarium filter 37 is operatively connected to the second aquarium 11 via a filter line 28. The second aquarium filter 37 circulates and filters the water in the second aquarium 11.

The first aquarium 10 is in fluid connection with the second aquarium 11 via the hollow connector 17, which is operatively mounted between the first aquarium 10 and second aquarium 11 and typically transparent. At least a portion 38 of the hollow connector 17 is not contained within the first aquarium 10 and the second aquarium 11 but is between the two, and provides means for fluidly connecting the first and second aquariums 10, 11 and provides for an appearance that the second aquarium is “floating” or suspended in midair. The hollow connector 17 has a hollow core 20 and a plurality of openings 18. The openings 18 provide passageway from the first aquarium 10 to the second aquarium 11 via the hollow core 20 of the hollow connector 17. In the preferred embodiment, a first end 21 of the hollow connector 17 is open and serves as the opening 18 to the second aquarium 11, and the openings 18 for passage from the hollow connector 17 to the first aquarium 10 are in a circumference of the hollow connector 17 between the top 14 and a distal end 22 of the hollow connector 17. In an alternative embodiment, the first end 21 of the hollow connector 17 is mounted to the top 24 of the second aquarium 11, and the openings 18 to the second aquarium 11 are in the circumference of the hollow connector 17 between the bottom 23 and the top 24 of the second aquarium 11. In another alternative embodiment shown in FIG. 2, the distal end 22 of the hollow connector 17 has an open end 39, which serves as the opening to the first aquarium 10. The hollow connector 17 is held in place by a bracket 40 attached to the top edges 15 of the first aquarium.

To use the aquatic habitat 50, water is added to a cavity 29 of the first aquarium 10 until the water level is proximate the top edges 15 and the top 14. The water will partially fill the hollow connector 17 but will not completely fill the second aquarium 11 because of the pressure between the water and the top 24 of the second aquarium 11. To fill the second aquarium 11, a vacuum is created in the second aquarium 11 via the vacuum port 26 and the vacuum pump to evacuate entrapped air between the top of the water level in the hollow connector 17 and the top 24 of the second aquarium 11. When the vacuum between the top of the water level in the hollow connector 17 and the top 24 of the second aquarium 11 is established, the water will begin to move up the hollow connector 17 and into the second aquarium 11. The water inlet 38 can be used to add water.

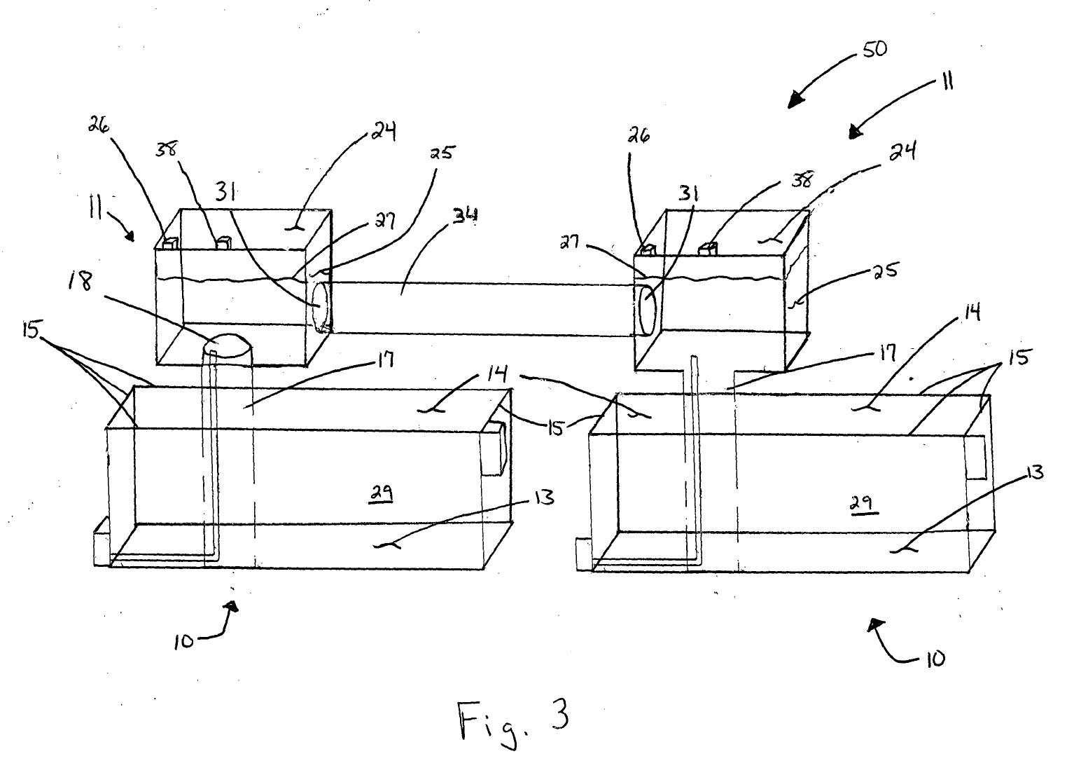

FIG. 3 shows another embodiment of the aquatic habitat 50 of the present invention having multiple first and second aquariums 10, 11 fluidly connected to each other via the hollow connector 17 and a hollow aquarium connector 34. The hollow aquarium connector 34 has openings 31 at each of its ends. The hollow aquarium connector 34 is hermetically sealed to the second aquariums 11. The hollow aquarium connector 34 has a hollow core providing a passageway from one of the aquariums 11 to another.

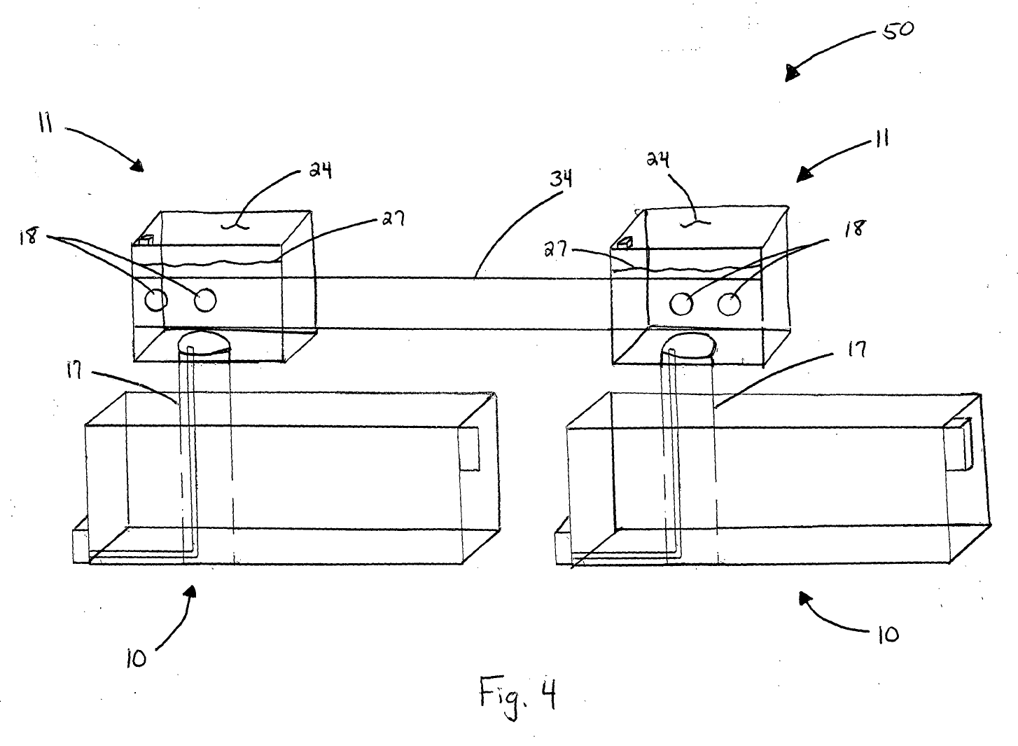

FIG. 4 shows another alternative embodiment of the aquatic habitat 50. The hollow aquarium connector 34 has the openings 18 in its circumference.

To use the aquatic habitat 50 shown in FIG. 3 or 4, water is added to the cavities 29 of the first aquariums 10 until the water level is proximate the top edges 15 and the tops 14. The water will partially fill the hollow connectors 17 but will not completely fill the second aquariums 11 because of the pressure between the water and the tops 24 of the second aquariums 11. To fill the second aquariums 11, a vacuum is created in the second aquariums 11 via the vacuum ports 26 and the vacuum pumps to evacuate entrapped air between the top of the water level in the hollow connectors 17 and the tops 24 of the second aquariums 11. When a vacuum between the tops of the water level in the hollow connectors 17 and the tops 24 of the second aquariums 11 is established, water will begin to move up the hollow connectors 17 and into the second aquariums 11. The water inlets 38 can be used to add water.

It is apparent to those skilled in the art that any number of aquariums 10, 11; hollow connectors 17; and/or hollow aquarium connectors 34 can be used to construct the aquatic habitat 50 of almost unlimited size and extent. The aquariums 10, 11; hollow connectors 17; and/or hollow aquarium connectors 34 can be fabricated to various lengths, heights, widths or diameters. Moreover, elbow connectors (not shown) can be used to hermetically connect the aquariums 10, 11; hollow connectors 17; and/or hollow aquarium connectors 34 creating an aquatic habitat of essentially any shape. The elbow connectors can be fabricated to various angles such as, but not limited to, forty or ninety degrees. “T” and “L” shaped connectors can also be used to hermetically connect the aquatic habitat.

The aquatic habitat 50 may extend throughout a home or office. Each room in a home or office may contain one or more of the aquariums 10, 11; hollow connectors 17; hollow aquarium connectors 34; elbow connectors; and/or other shaped connectors. The size of the aquatic habitat 50 is left to the imagination of the person assembling it.

Modifications and substitutions by one of ordinary skill in the art are considered to be within the scope of the present invention, which is not to be limited except by the following claims.

1. An aquatic habitat for holding fluid therein, comprising:
a first aquarium having a container for holding the fluid at a fluid level;
a second aquarium having a second container for holding the fluid; and
a hollow connector fluidly connecting the first aquarium to the second aquarium, said hollow connector having at least a portion of its length above the fluid level in the first aquarium.

2. The aquatic habitat according to claim 1, wherein the second aquarium has a top, and further comprising a vacuum port for evacuating air between the fluid in said second aquarium and the top of the second aquarium.

3. The aquatic habitat according to claim 2, further comprising a vacuum pump operatively attached to the vacuum port.

4. The aquatic habitat according to claim 2, wherein said second aquarium further includes a fluid inlet port for adding fluid to the aquatic habitat.

5. The aquatic habitat according to claim 4, wherein the vacuum port and the water inlet port are one valve.

6. The aquatic habitat according to claim 1, wherein the first aquarium has a bottom and the second aquarium has a top, and further comprising means for creating a vacuum between a fluid level in said second aquarium and the top of the second aquarium, thereby causing the fluid to move into the second aquarium proximate to its top.

7. The aquatic habitat according to claim 6, wherein the fluid has a top surface that moves away from the bottom of the first aquarium and towards the top of the second aquarium as the vacuum is produced.

8. The aquatic habitat according to claim 1, wherein the hollow connector has a first end, a distal end, and a longitudinal cavity extending from the first end to the distal end, and wherein the first end is operatively connected to the first aquarium and the distal end operatively connected to the second aquarium, thereby providing a passageway from the first aquarium to the second aquarium.

9. The aquatic habitat according to claim 8, wherein the hollow connector has apertures proximate its first and distal ends.

10. An apparatus for holding aquatic animals and water therein, comprising:
a first aquarium having a cavity for holding the water at a level and having an opening at a top portion thereof;
a second aquarium having a cavity for holding the water and having an opening at a bottom;
a hollow connector having a first end, distal end, and a tubular cavity extending longitudinally from the first end to the distal end, and the hollow connector being in fluid connection with the first aquarium and the second aquarium; and
wherein the hollow connector has a portion outside the cavities of the first and second aquariums and above the water level in the first aquarium.

11. The apparatus for holding aquatic animals and water according to claim 10, further including a vacuum port for evacuating air between the water level and a top of the second aquarium.

12. The apparatus for holding aquatic animals and water according to claim 10, further including a pump operatively attached to the vacuum port for removing air out of the apparatus via the vacuum port.
